(19) United States
(12) Patent Application Publication
(10) Pub. No.: US 2005/0241999 A1
(43) Pub. Date: Nov. 3, 2005

(54) Method for the optimisation of reagent dosages in a concentration plant

(76) Inventor: Veikko Palosaari, Pori (FI)

Correspondence Address: MORGAN & FINNEGAN, L.L.P., 3 WORLD FINANCIAL CENTER, NEW YORK, NY, 10281-2101, US

(21) Appl. No.: 10/527,181

(22) PCT Filed: Sep. 30, 2003
(86) PCT No.: PCT/FI03/00706

§ 371 Date: Mar. 7, 2005

(30) Foreign Application Priority Data
Oct. 2, 2002 (FI) 20021748

(51) Int. Cl. B03D 1/14

(52) U.S. Cl. 209/164

(57) ABSTRACT

The invention relates to a method for controlling the reagent dosages in a concentration plant. In accordance with the method, a small part of the concentration plant feed is conducted to a side stream, where the feed is handle and variables required in dimensioning the reagent amount is measured. The reagent dosages of the main stream are determined according to the results obtained from the side stream.

The present invention relates to a method of controlling the reagent dosages in a concentration plant. In accordance with the method, a small part of the concentration plant feed is conducted to a side stream, where the feed is handled and variables required in dimensioning the reagent amount are measured. The reagent dosages of the main stream are determined according to the results obtained from the side stream.

Rapid variation in the properties of concentration plant feed is common if the feed is not homogenized in the plant effectively enough. Variation may result from changes in the content of valuable and gangue substances in the solid material, variation in structural factors, changes in the particle size distribution or variations caused by the process water. In these cases the dosage of reagents can become problematic and lead to the poor controllability of the process. Too small quantities of collectors and frothers result in low yields in the concentrator (concentration plant) whereas too large amounts lead to increased reagent costs and poor selectivity. Too low dosages of depressants result in poor selectivity and large dosages for instance in problems of frothing, high costs and loss of yield.

Several procedures and alternative processes have been used to control the reagent dosages and to reduce the need for control due to variation in feed, and they are described below. None of them however, have led to a result that is good regarding either the quality of the end product or its economy.

In present-day concentration plants reagent dosage is usually adjusted using observations, measurements or e.g. feedback from an on-line analyser of the flotation circuit. This method does not allow for forecast adjustment and rapid changes in the feed remain undetected, creating problems in circuit control.

One method developed for the control of variations in feed is the separation-flotation of naturally floating minerals such as talc and routing the floated concentrate to waste. Selective flotation of naturally floating minerals succeeds however only with pure water and needs to have several cleaning stages. Circulating waters generally contain residues of collector reagents and thus losses of valuable minerals into the product rise considerably.

Another method used to control feed variation is the effective homogenization of the feed material. Arranging for effective homogenization does not generally succeed in practice either due to the high cost of the system or the oxidation of sulphide minerals.

One method that is generally used is the dosing of reagents, which is performed according to the estimated average consumption. The result is an occasional over- or underdosing of reagents leading to either a concentrate of poor quality or losses of valuable minerals.

Yet another method used is the evaluation of reagent dosing using estimates based on mining data. The evaluation of the timing and extent of variations is however difficult and faulty estimates lead to the problems mentioned in the previous paragraph. Estimation requires careful planning and control of mining, and adds to sampling and analysis costs.

Now a method has been developed which enables the determination of the quality and process behaviour of the feed at the earliest possible stage and this determination enables the adjustment of the feed of reagents for a good end result. In accordance with the method, a representative side stream is separated from the feed at the earliest possible stage in the concentration plant, and this side stream is routed to a calibration circuit. The side stream is treated according to an optimized standard method, whereby the variables required in measuring the reagent demand are determined. These are for instance froth formation and amount of concentrate. When measuring the quantity and quality of reagent the valuable and gangue material content of the concentrtae is also measured. On the basis of the results obtained, the reagent dosage of the main stream is forecast and adjusted. The optimized standard method used may be for example estimated average feed chemical dosages and flotation conditions or other standard conditions, that guarantee good results in the measurement of changes caused by variation in feed.

The essential features of the invention will be made apparent in the attached claims.

In the method now developed, a side stream of the feed is taken, for example after primary grinding, and routed to a calibration circuit. The calibration circuit can be for instance a conditioner and row of cells or even a single flotation cell. When the process behaviour of the feed has been measured in the side stream, the results are used to determine the reagent requirements for the main stream. After this the main stream can be directed to the next process stages such as secondary grinding and conditioning. If necessary the main stream can also be routed for instance to a thickener or storage tank, which provides a sufficient delay for the calibration results to become available before the main stream feed is routed to the equivalent process stage. The side stream operates preferably as a continuous process and the results are used as control variables for the reagent dosage of the main stream in real time.

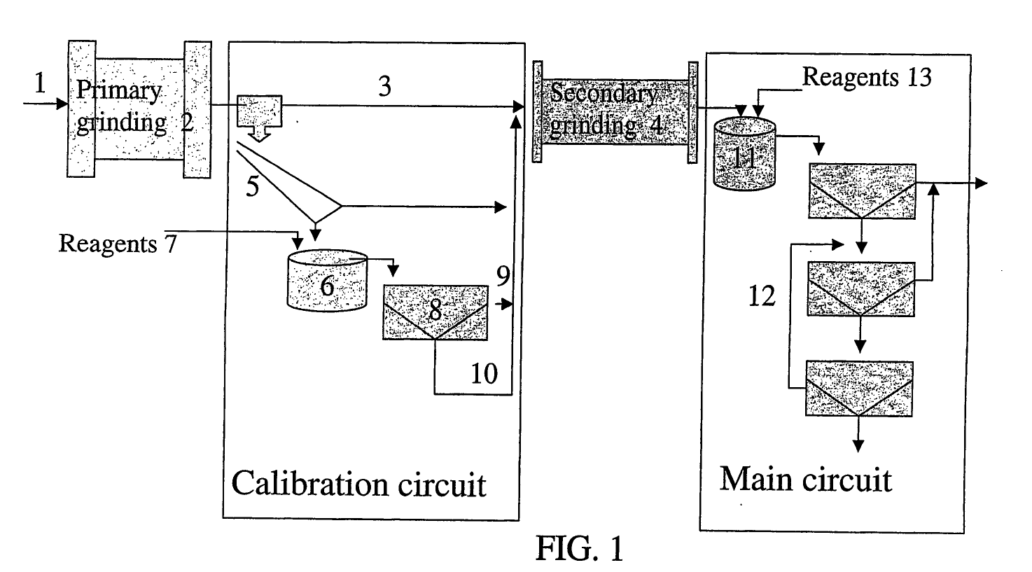

The method in accordance with the invention is described further by FIG. 1, which shows the process flowsheet of the method.

According to the process flowsheet all the feed 1 is fed to primary grinding 2, from where a small amount is separated e.g. using a sampler and sieve to a calibration circuit as the main stream 3 continues its way to the next stage, which in this case is secondary grinding 4. The calibration circuit feed 5 is fed to a conditioner 6, to which reagents 7 are also added. The feed is fed from the conditioner to a flotation cell 8. The overflow 9 and underflow 10 of the flotation cell are analysed (not shown in detail) and fed back to the main stream 3. The main stream is fed to the main circuit, which comprises normal concentration equipment such as a conditioner 11 and flotation circuit 12. The flotation circuit consists of one or several flotation cells. Based on the information obtained from the calibration circuit, the amount and composition of the reagents 13 to be fed into the main circuit is adjusted in order to achieve a good concentration result.

1. A method for controlling of reagent dosages in a concentration plant based on the variation in the properties of a raw material feed, characterized in that a representative side stream of the raw material feed is formed, which is fed to a calibration circuit, where variables required in measuring the amount and quality of reagents are determined and the variables obtained are used to dimension the feed of reagents in the main stream.

2. A method according to claim 1, characterized in that the calibration circuit contains required conditioning and flotation stages.

3. A method according to claims 1 or 2, characterized in that a side stream of the raw material is formed after a primary grinding stage.

4. A method according to any of the above claims, characterized in that after primary grinding the main stream is fed to secondary grinding, to which the product from the calibration circuit is also fed.

5. A method according to claims 1, 2 or 3, characterized in that after primary grinding the main stream is fed to a storage tank.

6. A method according to any of the above claims, characterized in that froth formation is measured when dimensioning the quantity and quality of reagent.

7. A method according to any of the above claims, characterized in that the amount of concentrate is measured when dimensioning the quantity and quality of the reagent.

8. A method according to any of the above claims, characterized in that the valuable and gangue material content of the concnetrate is measured when dimensioning the quantity and quality of the reagent.
